(19) United States
(12) Patent Application Publication
(10) Pub. No.: US 2020/0192989 A1
(43) Pub. Date: Jun. 18, 2020

(54) LARGE SCALE SIMULATOR FOR AIRBORNE OBJECTS

(71) Applicant: Loon LLC, Mountain View, CA (US)

(72) Inventors: Sameera Sylvia Ponda, Mountain View, CA (US); Salvatore J. Candido, Mountain View, CA (US); Jacob Buswell Roberts, San Francisco, CA (US)

(21) Appl. No.: 16/531,268

(22) Filed: Aug. 5, 2019

Related U.S. Application Data
(60) Provisional application No. 62/781,302, filed on Dec. 18, 2018.

(51) Int. Cl. G06F 17/50; G06F 9/455; G05B 17/02; B64C 39/02

(52) U.S. Cl. CPC G06F 17/5009; G06F 9/45558; G05B 17/02; B64C 2201/141; G06F 2009/45595; G06F 2217/10; B64C 39/024

(57) ABSTRACT

The technology relates to risk assessments associated with a life cycle of one or more airborne objects. For instance, this may comprise running Monte Carlo simulations using operational parameters of the airborne object for a predetermined time period and on a plurality of processing devices distributed on a network and over ranges of values for the operational parameters. A risk threshold is then calculated for at least one of the Monte Carlo simulations and used in adjusting a flight component of the airborne object.

### CROSS-REFERENCE TO RELATED APPLICATIONS

This application claims the benefit of the filing date of U.S. Provisional Application No. 62/781,302, filed Dec. 18, 2018, the entire disclosure of which is incorporated by reference herein.

### BACKGROUND

Computing devices such as personal computers, laptop computers, tablet computers, cellular phones, and countless types of Internet-capable devices are increasingly prevalent in numerous aspects of modern life. As such, the demand for data connectivity via the Internet, cellular data networks, and other such networks, is growing. However, there are many areas of the world where data connectivity is still unavailable, or if available, is unreliable and/or costly. Accordingly, additional network infrastructure is desirable.

### BRIEF SUMMARY

Aspects of the present technology are advantageous for high altitude systems, such as High Altitude Platforms (HAPs), High Altitude Long Endurance (HALE) unmanned aerial vehicles (UAVs), e.g., stratospheric balloons, fixed wing vehicles and other aircraft, as they provide timely simulation output for all the balloons and/or their associated systems. This enables accurate and timely risk assessment of the life cycle of the balloons and their associated systems. The resultant information may be used to manage balloon flight path and operational characteristics, mitigate against unplanned balloon down time and, more generally, manage network operations to maintain network service at desired levels.

According to one aspect, a method for forecasting risk factors for an airborne object controlled based on flight model parameters is provided. This method comprises running a Monte Carlo simulation using a given set of the flight model parameters of the airborne object for a predetermined time period, wherein the Monte Carlo simulation is distributed across a plurality of processing devices and run over ranges of values for the given set of flight model parameters. The method also includes generating by one or more processors, within the predetermined time period, a risk threshold as a result of the Monte Carlo simulation, the risk threshold comprising a measure of an expected life cycle associated with the airborne object; and determining whether to adjust a flight component of the airborne object based on the risk threshold.

In one example, the given set of flight model parameters comprises one or more of a power level of a battery of the airborne object, a zero pressure condition of the airborne object, a location of the airborne object, or a weather parameter associated with a flight path of the airborne object.

In another example, the method further comprises terminating the Monte Carlo simulation if the risk threshold is not generated within the predetermined time period. In a further example, the method further comprises repeatedly running the Monte Carlo simulation and generating a respective risk threshold for each repeated run.

The plurality of processing devices may comprise a plurality of virtual machines. Here, the plurality of virtual machines may be distributed over a computer network. And one or more of the given set of flight model parameters may be allocated to different ones of the plurality of virtual machines during running of the Monte Carlo simulation.

In yet another example, the predetermined time period is on a time scale of seconds, minutes or hours.

The method may further include adjusting the flight component of the airborne object while the airborne object is in flight. And the Monte Carlo simulation may be run while the airborne object is in flight.

According to another aspect, a simulator system is provided. The simulator system includes a plurality of computing devices distributed on a network, one or more computer readable storage media, and program instructions stored on the one or more computer readable storage media for execution by the plurality of computing devices. The program instructions comprise: running a plurality of discrete Monte Carlo simulations, each discrete Monte Carlo simulation being run for an operational parameter of an airborne object for a predetermined time period and on the plurality of computing devices distributed on the network and over a range of values for the operational parameter; generating, within the predetermined time period, a risk threshold for at least one of the plurality of discrete Monte Carlo simulations, the generated risk threshold comprising a risk assessment measure associated with a life cycle of the airborne object; and outputting the risk threshold to a control system associated with the airborne object.

In one example, the simulator system further comprises the control system. Here, the control system is configured to adjust a flight path of the airborne object according to the risk threshold while the airborne object is in flight.

In another example, the program instructions are further configured to cause the plurality of computing devices to terminate a given one of the discrete Monte Carlo simulations when the risk threshold is not generated within the predetermined time period. The plurality of discrete Monte Carlo simulation may be run while the airborne object is in flight.

In a further example, the plurality of computing devices comprises a plurality of virtual machines, and the plurality of discrete Monte Carlo simulations is distributed across the plurality of virtual machines. Here, the plurality of virtual machines may be distributed over a computer network.

According to another aspects, a method is provided for managing risk assessment for a life cycle of an airborne object while the airborne object is in flight. This method includes: running a plurality of discrete Monte Carlo simulations, each discrete Monte Carlo simulation being run using an operational parameter of the airborne object for a predetermined time period and on a plurality of processing devices distributed on a network and over a range of values for the operational parameter, generating, within the predetermined time period, a risk threshold for at least one of the plurality of discrete Monte Carlo simulations, the generated risk threshold comprising a risk assessment measure associated with the life cycle of the object; and adjusting a flight component of the object based on the generated risk threshold.

The plurality of discrete Monte Carlo simulations may be run in parallel. In this case, at least some of the plurality of discrete Monte Carlo simulations may be run using a same operational parameter. And at least some of the plurality of discrete Monte Carlo simulations may be run using different operational parameters of the airborne object.

### BRIEF DESCRIPTION OF THE DRAWINGS

FIG. 1 is a functional diagram of a system in accordance with aspects of the present disclosure.

FIG. 2 is an example of a balloon in accordance with aspects of the present disclosure.

FIG. 3 is an example of a balloon in flight in accordance with aspects of the disclosure.

FIG. 4 is an example server system in accordance with aspects of the disclosure.

FIG. 5 is a functional diagram in accordance with aspects of the disclosure.

FIG. 6 is an example outcome in accordance with aspects of the disclosure.

FIG. 7 is an example outcome in accordance with aspects of the disclosure.

FIG. 8 is an example outcome in accordance with aspects of the disclosure.

FIG. 9 is an example method according to aspects of the disclosure.

FIG. 10 is another example method according to aspects of the disclosure.

### DETAILED DESCRIPTION

Overview

One way to provide enhanced network access is via a network of balloons or other maneuverable platforms operating in the stratosphere. To maintain the network, each balloon (or other maneuverable platform) may be required to be located at and/or to travel to a particular location. The balloons may rely on ever-changing wind conditions to assist in navigation efforts to different locations. Other environmental and non-environmental factors can impact each balloon's flight plan. In view of this, large scale simulations may be performed to evaluate operational characteristics or capabilities (e.g., power system availability) and life cycle of individual balloons or an entire fleet. Such simulations may be used to manage the life cycle of the balloons that make up the network including, for example, risk management to avoid failure modes and/or optimize availability for service delivery.

This technology relates to evaluating the likelihood of life cycle events for multi-parameter/application large scale systems, such as for long-duration balloon flights. This allows for risk assessment, adjustment of system components to meet performance requirements, avoidance of system failure, and adjustment or otherwise optimization of system performance. In order for such simulations to be impactful, results should be provided on time scales that allow system functions to be adjusted or corrective measures to be invoked in a timely manner.

The number of applications or parameters, and overall system scale, create challenges in generating stable, repeatable simulation results which are required for large-scale multi-datacenter control systems to effect system adjustments that may timely impact system performance or avert undesirable operating conditions. According to aspects of the technology, running one or more timed Monte Carlo simulations across a plurality of computing resources on a single parameter or application provide results in a manner that allows for almost real time system monitoring and adjustment. More generally, the technology includes running a large ensemble of simulations with parameters sampled from distributions from which Monte Carlo estimates of statistics for one or more quantities of interest can be derived.

As an example, the flight plan of a system comprising a plurality of airborne objects, such as for example balloon and other HALE and/or HAP platforms (e.g., drone-type unmanned aerial vehicles) that operate at relatively high (stratospheric) altitudes, e.g., on the order of 20 kilometers above the earth's surface, needs to be monitored and adjusted based on a variety of operational and environmental parameters or applications. Operational parameters or applications may include, for example, preventing thermal runaway, balloon burst, a zero pressure condition or critically low levels of battery power. Balloon burst may occur when the pressure within the balloon exceeds tolerance limits of the balloon material. Zero pressure may result when the thermal environment changes (e.g., when the sun goes down and the balloon gets colder). One cause of zero pressure is loss of superpressure due to a change in temperature (e.g., typically a drop in temperature to relatively cold temperatures). This phenomenon occurs due to a change in temperature causing a loss of superpressure within the balloon envelope. There is also a slower lift gas process, which over time makes a balloon more susceptible to zero pressure (e.g., the temperature threshold creeps higher with loss of lift gas); however, in more severe cases temperature tends to dominate. Battery power levels may be dependent on factors such as, for example, access to sunlight by solar panels on the balloon platform, battery age which relates to its storage capacity, drain on battery power due to system load, etc. For example, a risk to guard against with respect to battery power is the risk of the batteries being drained below a threshold where they are able to provide power to the system when no charge is being generated. Environmental parameters include, for example, weather patterns or landscape over which the airborne object may travel. Other applications or parameters in addition to those discussed above include balloons being in close proximity to each other, population density in a region of interest, and merged risk assessments from different simulations or calculations.

These systems may comprise a large number of balloons or other platforms, e.g., tens to thousands, whose flight plans and operational capabilities need to be monitored and managed so that they are able to fulfill their purpose (e.g., deliver Internet access). In this regard, it is desirable to run simulations on each balloon in the system to predict, for example, potential flight paths, the possibility of running out of power during flight or the risk of flight termination.

Aspects of the technology run simulations for each balloon, airborne object or other flight system and alerts an operator such as a flight engineer if a flight plan or other operational component(s)/parameter(s)) of the balloon reaches or exceeds some risk threshold. Alternatively, the system may also be configured to automatically adjust the flight plan or other operational component(s)/parameter(s) autonomously based on such risk threshold. As another alternative, the system may alert other systems or operators, e.g., air traffic control. Simulations may be periodically run for all flight systems that are deployed so as to timely provide results by limiting a run time period and running the simulation for a single application or parameter. The run time period and/or period for running simulations may be selected in accordance with system scale and complexity. For instance, this may include the number of parameters or applications for which simulation is needed, the conditions that may impact those parameters and a range of parameter or application values over which the simulation needs to be run. In one scenario, simulations may be run every 10-60 seconds, or more or less. However, if the system is not relatively complex, that time or simulation frequency may be reduced. Conversely, if the system is more complex, the simulations may be run less frequently to better manage computing resources. Here, for instance, the time scale may be on the order of minutes (e.g., 1-60 minutes) or hours (e.g., 1-5 hours, or more). As an example, the run time period may be on the time scale of seconds, e.g., 10 seconds. However, that may be relaxed depending on the location of the airborne object or flight system or the number of flight systems that need to be simulated, or other factors. In order to meet these objectives, simulations may be run over a collection of computing devices.

Other factors that may impact run time or run time frequency may include how quickly circumstances are expected to change. For example, there may be an expectation that an assessment would only change if the parameters (e.g., location, time, vehicle state) vary considerably and those parameters change relatively or more slowly. In such a case running the simulation at a high rates might not be as useful.

As an example, the simulations may comprise a Monte Carlo service that runs periodically, e.g., every 1 to 10 seconds or every 1 to 10 minutes, or more or less. The service may include fields that allow selection of the particular application or parameter for which simulation is to be run. At a high level, the Monte Carlo service includes a step of generating simulation requests periodically, e.g., every 10 seconds. Each simulation request may be given a deadline or predetermined time limit for completion, e.g., a run time period of 10 seconds. Both the period at which requests are generated and run time period may be customizable to give flexibility to address the conditions discussed above, such as system scale and complexity. If the simulation does not provide results within the predetermined time limit, then the results can be discarded. Similarly, if the simulations are run over a range of values for the application or parameter and the simulation returns results for less than all the range of values, then those results can be discarded.

When simulations are run to completion, results are stored for use by a debugger or an automated flight system. By way of example, the automated system may use the results of the simulation to suggest suitable times or places for terminating a flight. For instance, a suitable time or place, may be a time or place where an engineer will be when the balloon arrives (e.g., an airfield at a given time). The results may also be used to change the course of the balloon. Thus, if a zero-pressure simulation indicates there is a risk that balloon pressure will reduce by an appreciable amount within a given time period, the flight path may be changed so as to navigate the balloon over a given geographical area that reduces the risk for zero-pressure. Conversely, if the simulation indicates that there is appreciable risk for balloon burst, then the flight path may be adjusted to avoid regions that would increase pressure, e.g., avoid flying over a desert or other hot spot. In addition, results are provided with a staleness time metric that allows avoidance of having aged results be relied on to adjust flight plans.

The technology may also be used to prioritize attention. For example, in an aviation program there may be one-to-many operation of flight vehicles. There may be 2 operators watching 10 balloons or other airborne vehicles. By providing a ranking of risk, the operators may devote more attention to the subset of balloons with the highest risk. Doing this automatically saves time (e.g., allows for scalability) and reduces mistakes/inattention (e.g., improves safety).

Another feature of the technology is the use of distributed computing resources. The availability of computing resources impacts run frequency and/or run time. The computing resources may comprise virtual machines in a cloud computing environment. The Monte Carlo simulation service may be distributed over multiple computing resources as part of a distributed computing architecture. In addition, this distributed architecture allows for simulations to be run in parallel for a given application, which mitigates the potential for simulations not returning results within the time limit required. The system is architected such that risk assessments for every flight in the fleet (e.g., every airborne platform in the fleet) can run in parallel separate from each other. As such, the system may grow to support an arbitrarily large fleet size as long as the service is allocated sufficient capacity (e.g., the number of machines in the datacenter). For example, the service may be implemented such that different applications or modules are allocated to different network resources. Simulations associated with the power module may be run in certain predetermined sets or allocations of computing resources (e.g., cells or shards), zero pressure in other sets of computing resources, etc. In this way the service is provided via a modular environment such that simulations for power, zero pressure, etc., may be run in parallel for each balloon in fleet in almost real time. The results for each simulation may then be aggregated to provide an overall risk assessment and provide feedback as to which risks are more significant than others or which airborne objects require more immediate attention than others.

This technology allows for running risk assessments of large scale and/or complex systems where time is an important factor in terms of feeding back simulation results into ongoing system operation. The use of distributed computing resources in concert with running a simulation on one application or parameter at a time and with predetermined run time limits allows the system to provide timely results. This allows for obtaining simulation results for systems that require consideration of multiple applications or parameters in almost real time to have continued or safe operation.

With regard to managing and assessing risk in a fleet of airborne balloons intended to deliver a particular service to a given geographic area, at a high level the system may allow for management of three basic effects for each module (e.g., power, zero pressure, etc.): dynamic risk adjustment through a side effect; alerting a human operator; and/or risk aggregation. Dynamic risk adjustment may take place as follows. If it is believed that a balloon is at too high a risk of running out of power, the module can dynamically adjust the power budget for some subsystem on the balloon to increase the margin to zero power and thus reduce the risk. Alternatively, if the margin is relatively high, the power budget can be increased for some subsystems to mitigate the risk level and usage of the system.

Risk aggregation may take place as follows. If a balloon has multiple modules reporting high risk, that balloon would appear riskier than another balloon with no modules reporting high risk. If a simulation for a balloon indicates there is a high risk of running out of power (module 1) and also a termination will likely cause it to land in a dense area (module 2), this would be considered riskier than a balloon that will run out of power over a field of unoccupied grass. The risk aggregation that is more significant requires more immediate attention. These aggregations can be used from everything from prioritizing attention to fleet health assessments, etc.

Alerting a human operator may involve sending an alarm to a human operator that a given risk is too high and the operator should take corrective action. This takes on additional importance for one to many operations in that the simulation system output is used to focus on which balloons or objects in the system require more attention than others.

Example System

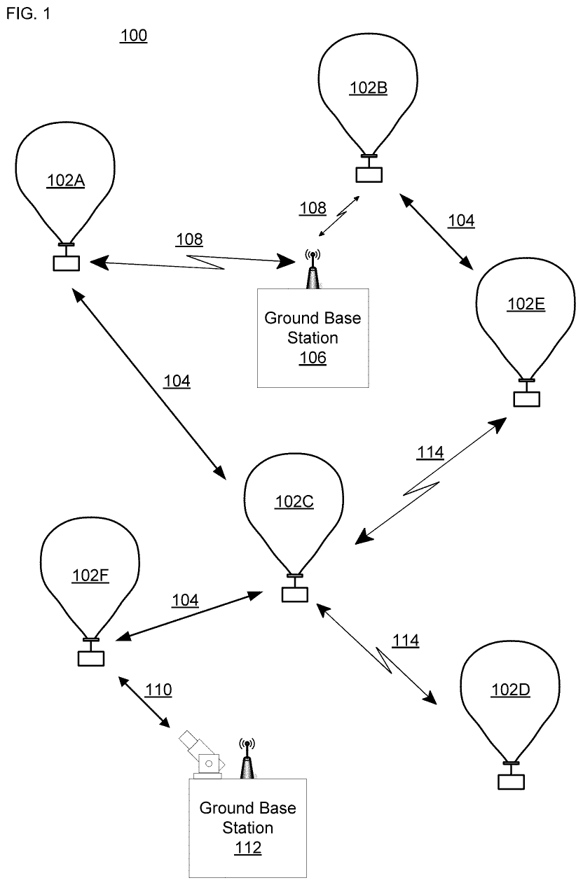

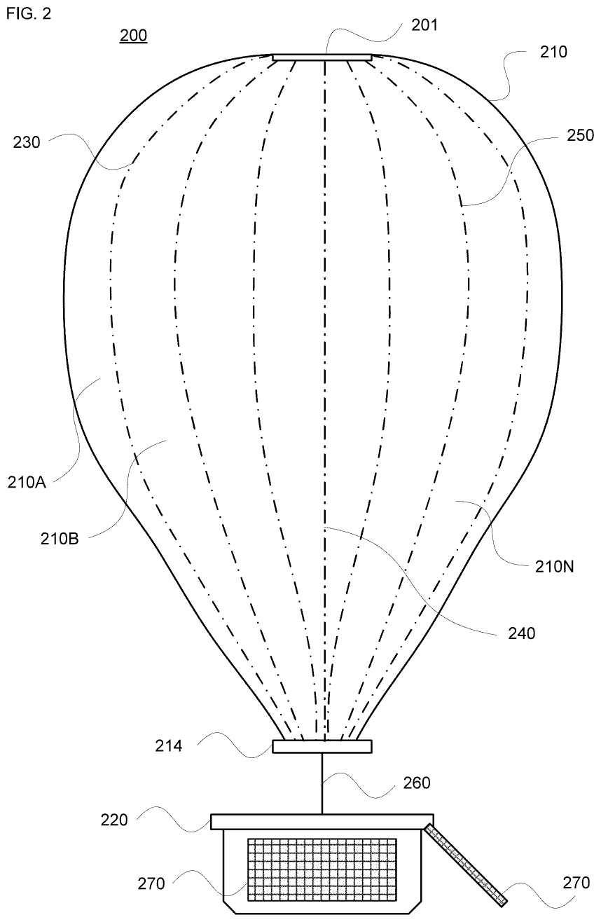

FIG. 1 depicts an example system 100 in which an airborne platform as described above may be used. This example should not be considered as limiting the scope of the disclosure or usefulness of the features of the present disclosure. For example, the techniques described herein can be employed on various types of airborne platforms and systems. In this example, system 100 may be considered a “balloon network”, though in addition to balloons the network may include other types of airborne platforms such as drones. As shown in FIG. 1, the system 100 includes a plurality of devices, such as balloons 102A-F, ground base stations 106 and 112 and links 104, 108, 110 and 114 that are used to facilitate inter-balloon communications as well as communications between the base stations and the balloons. The links may be optical and/or radio frequency communication links. One example of a balloon is discussed in greater detail below with reference to FIG. 2.

Example Balloon

FIG. 2 is an example balloon 200, which may represent any of the balloons of the system 100. As shown, the balloon 200 includes an envelope 210 and a payload 220. The balloon envelope 210 may take various forms. In one instance, the balloon envelope 210 may be constructed from materials such as polyethylene that do not hold much load while the balloon 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof; such as helium, hydrogen or any other lighter-than-air gas. The envelope 210 is thus arranged to have an associated upward buoyancy force during deployment of the payload 220.

The payload 220 of balloon 200 may be affixed to the envelope by a connection 260 such as a cable, tube or other semi-rigid or rigid structure. The payload 220 may include a computer system (not shown), having one or more processors and on-board data storage (similar to processors 420 and memory 430 described below). The payload 220 may also include various other types of equipment and systems (not shown) to provide a number of different functions. For example, the payload 220 may include various communication systems such as optical and/or RF components, a navigation system, a positioning system (e.g., GPS), a lighting system, an altitude control system (configured to change an altitude of the balloon), a plurality of solar panels 270 for generating power, and a power supply (such as one or more batteries) to store and supply power to various components of balloon 200.

In view of the goal of making the balloon envelope 210 as lightweight as possible, it may be comprised of a plurality of envelope lobes or gores that have a thin film, such as polyethylene or polyethylene terephthalate, which is lightweight, yet has suitable strength properties for use as a balloon envelope. In this example, balloon envelope 210 is comprised of envelope gores 210A-210D.

Pressurized lift gas within the balloon envelope 210 may cause a force or load to be applied to the balloon 200. In that regard, tendons 230, 240, 250 provide strength to the balloon 200 to carry the load created by the pressurized gas within the balloon envelope 210. In some examples, a cage of tendons (not shown) may be created using multiple tendons that are attached vertically and horizontally. Each tendon may be formed as a fiber load tape that is adhered to a respective envelope gore. Alternately, a tubular sleeve may be adhered to the respective envelopes with the tendon positioned within the tubular sleeve.

Top ends of the tendons 230, 240 and 250 may be coupled together using an apparatus, such as top cap 201 positioned at the apex of balloon envelope 210. A corresponding apparatus, e.g., bottom cap 214, may be disposed at a base or bottom of the balloon envelope 210. The top cap 201 at the apex may be the same size and shape as and bottom cap 214 at the bottom. Both caps include corresponding components for attaching the tendons 230, 240 and 250 to the balloon envelope 210.

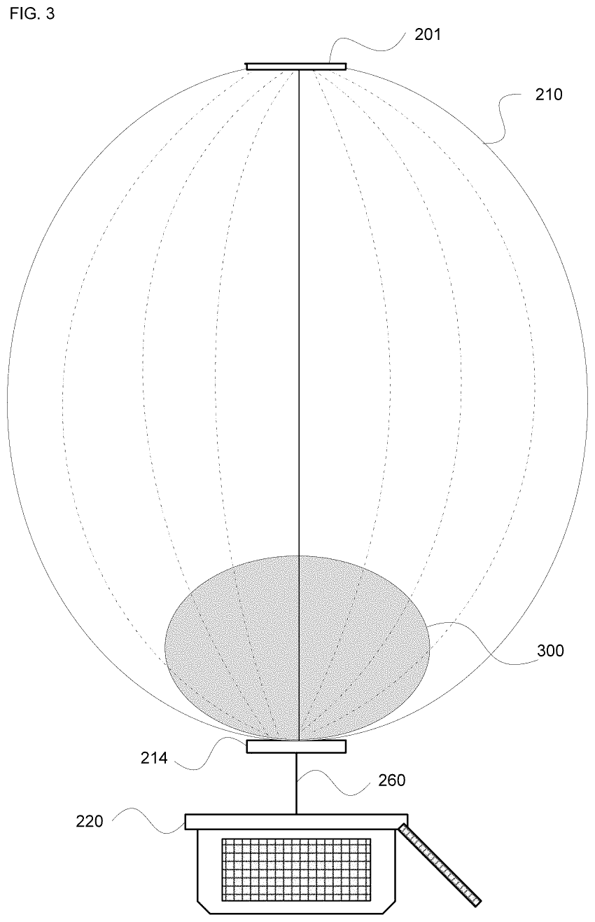

FIG. 3 is an example of balloon 200 in flight, for instance at float altitude. In this example, the shapes and sizes of the balloon envelope 210, connection 260, and payload 220 are exaggerated for clarity and ease of understanding. An inflatable bladder, or ballonet 300, provides ballasting for the balloon 200. During flight, balloons may use changes in altitude to achieve navigational direction changes. For example, the altitude control system of the payload 220 may cause air to be pumped into the ballonet 300 within the balloon envelope 210, which increases the mass of the balloon and causes the balloon to descend. Similarly, the altitude control system may cause air to be released from the ballonet 300 (and expelled from the balloon) in order to reduce the mass of the balloon and cause the balloon to ascend. By controlling the balloon's buoyancy, the balloon can be driven up and down in the atmosphere or held at a constant altitude for long duration flights. Altitude control thus enables some form of navigation for the balloon.

Example Server System

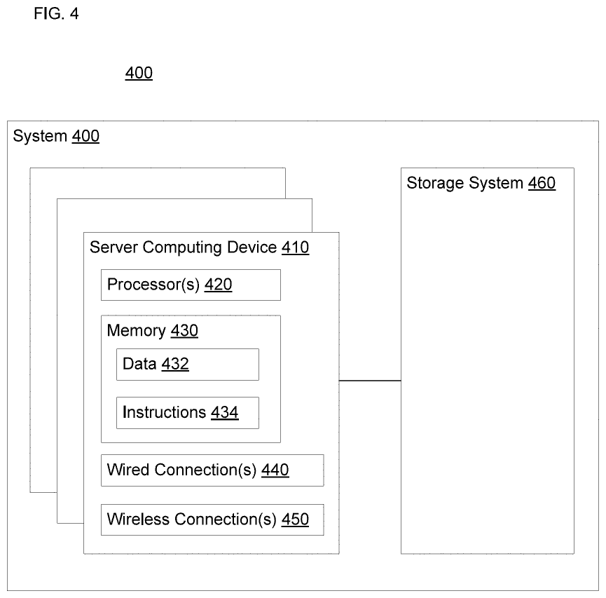

FIG. 4 is an example of a server system 400 which may be, for instance, incorporated into one or more of the ground base stations 106, 112 of FIG. 1. As shown, the server system 400 includes one or more server computing devices 410 and a storage system 460. In one scenario, each ground base station 106, 112 may be a datacenter including the storage system 460 as well as the server computing devices 410. In this regard, the server computing devices may function as a load balanced server farm in order to exchange information with different nodes of various networks for the purpose of receiving, processing and transmitting the data to and from other computing devices. As such, each of the one or more server computing devices 410 may include one or more processors 420, memory 430 and other components typically present in general purpose computing devices.

The memory 430 stores information accessible by the one or more processors 420, including instructions 434 and data 432 that may be executed or otherwise used by the processor 420. The memory 430 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 434 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 432 may be retrieved, stored or modified by processor 420 in accordance with the instructions 434. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processors 420 may be any hardware-based processors, such as commercially available central processing units (CPUs) and/or graphics processing units (GPUs). Alternatively, the one or more processors may be a dedicated device such as an ASIC or other hardware-based processor. Although FIG. 4 functionally illustrates the processor, memory, and other elements of computing device 400 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of server computing devices 410. Accordingly, references to a processor or computing device will be understood to include references to a collection of processors or computing devices or memories that may or may not operate in parallel.

The server computing devices 410 may also include one or more wired connections 440 and/or wireless connections 450 to facilitate communication with other devices, such as other server computing devices 410 and the storage system 460, one or more information services, and other devices of the network 100. These information services may include, for instance, systems that provide weather predictions from organizations such as the National Oceanic and Atmospheric Administration (NOAA) or the European Centre for Medium-Range Weather Forecasts (ECMWF). The wireless network connections may include short range communication protocols such as Bluetooth™, Bluetooth™ low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Storage system 460 may store various types of information as described in more detail below. This information may be retrieved or otherwise accessed by one or more server computing devices, such as the server computing devices 410, in order to perform some or all of the features described herein. As with memory 430, storage system 460 can be of any type of computer storage capable of storing information accessible by the server computing devices 410, such as a hard-drive, memory card, ROM, RAM, DVD, CD-ROM, write-capable, and read-only memories. In addition, storage system 460 may include a distributed storage system where data is stored on a plurality of different storage devices which may be physically located at the same or different geographic locations. Storage system 460 may be connected to the server computing devices 410 directly (e.g., as part of server computing devices 410 and/or via wired connections 440) and/or via a network (e.g., via wired connections 440 and/or wireless connections 450). This network may include various configurations and protocols including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Example Methods

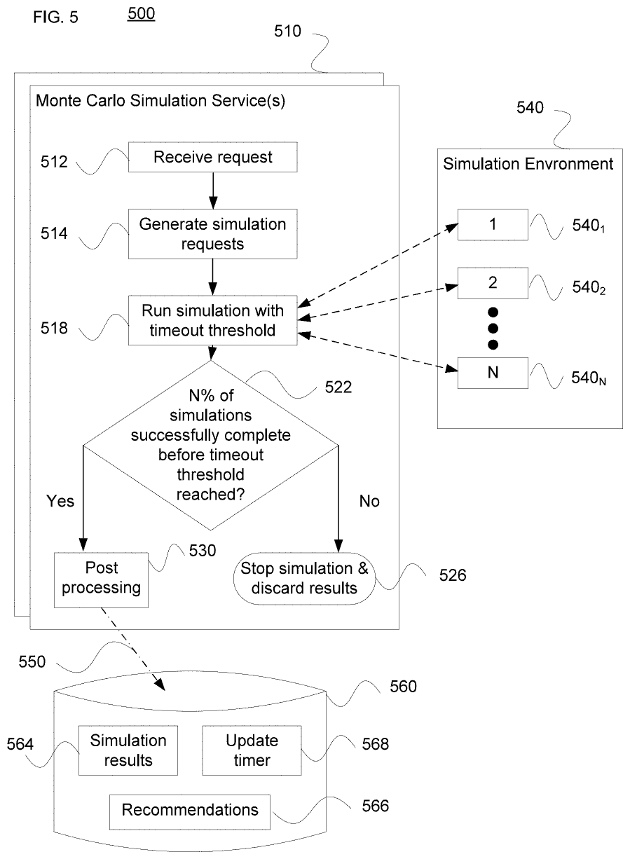

In addition to the operations described above and illustrated in the figures, various operations will now be described. It should be understood that the following operations do not have to be performed in the precise order described below. Rather, various steps can be handled in a different order or simultaneously, and steps may also be added or omitted. For instance, FIG. 5 is an example functional system diagram 500 that implements a simulation environment in accordance with aspects of this disclosure. As shown, the system may comprise one or more service blocks 510 that run in a simulation environment 540 and that provides output to storage system 560. In running simulations or implementing the technology, consideration should be given to having the quantities of interest uncorrelated with simulation failures that may occur in practice or the threshold for the number of simulation failures is chosen such that the level of bias being introduced into the system is bounded. For example, under certain conditions accepting a subset of simulation results may act as a method of rejection sampling and impact the accuracy of estimates of the quantities of interest. This may result in the risk assessment being biased. Multiple service blocks 510 may run in parallel or otherwise concurrently. Here, each service block may be of the same type, running the same simulation. Alternatively, each service block may be of a different type to address different service requests (e.g., zero pressure analysis, battery life analysis, etc.).

The service block 510 comprises a flow diagram of operations that may run on one or more of the computing devices 410 of FIG. 4. Service block 510 may, for example, comprise a Monte Carlo-type service. Monte Carlo simulations, for example, may be run using a distribution of model parameters, which allows for managing flight plans and allocating risk probabilistically. A feature of these simulations is thus a prediction of a likelihood of resulting outcomes. For example, the outcome may comprise a range of probabilities of running out of power given a range of input battery levels and a desired destination, flight path, balloon collision risk, subsystem component use, likelihood of encroaching into restricted/no fly airspace, etc. Thus, for a given Monte Carlo simulation, a value is chosen for a given parameter based on a range of estimated or known probable values. Other parameters associated with the system being simulated are then fixed, and the simulation is run for the given parameter value based on a model. More generally, one or more parameters can be sampled while other parameters are fixed (e.g. sample battery level, heater power loads, etc.). The outcome of the simulation indicates the probability of a particular event or task occurring, e.g., given a particular battery level getting to a desired location. The value of the given parameter is then modified within the range and the simulation repeated with the other parameters fixed. The process may then be repeated for different values of the given parameter so as to generate a probability distribution. The probability distribution represents risk assessment over the range of given parameter values that are simulated.

For example, let X1 and X2 be parameters and Y be the quantity of interest. Both X1 and X2 will have some distribution. An algorithm may then comprise:
For i=1 to many:
   Sample X1 for distribution(X1)
   Sample X2 for distribution(X2)
   Y=f(X, X2)
   Accumulate statistics of Y
This gives an estimate of P(Y=y) for all y, and some statistics may then be used as part of the risk assessment. This represents Monte Carlo estimation. Next, ranging may be done over some parameters to determine the sensitivity to that parameter or what would occur if a given parameter is believed to be at a given value. The procedure may then comprise:
   For i=1 to many:
      Sample X2 for distribution(X2|X1=x1)
      Y=f(X1, X2)
      Accumulate statistics of Y
This gives an estimate P(Y=y|X1=x1). These represent two possible but related approaches that may be taken in accordance with aspects of this technology.

As shown in service block 510, the Monte Carlo service begins with receiving a request to generate a simulation, at block 512. The request may come from an operator such as a flight or system engineer, or from the system itself. The request may indicate specific components, subsystems and/or features of those components or subsystems to evaluate. In response to the received request, one or more simulation requests are generated at block 514. In the context of a fleet of balloons such as those described with respect to FIGS. 1 through 3 above, simulations are run autonomously and continuously. Simulations may also be requested by operators or others with access and permission to do so. Simulation results may be requested by one or more operators. Such operators may be responsible for multiple balloons within the fleet as part of a one-to-many operation of the balloons and their associated systems. Simulations may involve simulation of one or more operational parameters, modules or applications for a given balloon. Such parameters, modules or applications may include, for instance, pressure (or height), altitude above sea level, vertical velocity, rotational velocity, horizontal velocity, relative rotations of components of the balloon, a despin mechanism (that adjusts for the relative rotations), gas composition of the gasses in the envelope, a super pressure limit (how high the balloon can go before failing or starting to experience failure), percentage of total volume of the ballonet, status of the various components of the balloon (whether anything has been damaged), thermal conditions of the components of the balloon, envelope composition (the type of film, configuration and shape of the balloon), solar conditions (relative location of the sun), battery configuration and state (number, capacity, currently charging or discharging, rates of same, current charge level, low battery limit, etc.), energy conditions (net energy loss or gain between incoming solar power and outgoing power to the components of the balloon), structure and configuration of the solar panels (number, physical arrangement, power output, etc.), altitude control system parameters (state, current target pressure or altitude), payload component conditions (power consumption rates under different payload conditions, efficiency, speeds of various motors, radio frequency and/or optical communications configurations, and various other parameters related to the balloon and/or the environment in which the balloon is being flown.

For instance, simulation may be requested regarding the power management system. In particular, the simulation request may comprise obtaining a measure of the risk of the battery level of a balloon reaching a critical level during a flight plan segment or within a certain time period. The power system module or application for the purposes of this example may include the following components: battery level, charge rate, and load discharge rate. Multiple simulations, e.g., thousands, are then run in the simulation environment 540 over a distribution of values associated with the components. The values of the components of all the modules or applications associated with a simulated balloon or system will typically be made available to the simulation service 510 as part of processing a request. Therefore, the request itself will typically include a balloon identifier and the application or module for which simulation is sought.

The simulation may operate on one module or application at a time. Therefore, in keeping with this example, while simulations for the power system module or application are being run, all the other modules or applications associated with the balloon for which simulation is requested are kept in their static condition. As another example, if a simulation is being run to assess the risk of zero pressure, then no simulation will be done on the power application or any other application.

Returning to the power system module example, once the request is received, the current or starting values of the battery level, charge rate, and load discharge rate components will be obtained. Simulations are then run for different values of these components with the outcome or result of the simulation being a predicted position of the balloon. Different values of components may be randomly assigned within allowed limits so that the outcome of the simulation is a probability of the balloon being at a particular position at a later point in time. One example is shown below.

| | % Result of the Simulation |
|---|---|
| Position | (e.g., out of 1,000 simulations) |
| (long1, lat1, alt1) | 90% |
| (long2, lat2, alt2) | 70% |
| (long3, lat3, alt3) | 20% |
| (long4, lat4, alt4) | 5% |
| (long5, lat5, alt5) | 0% |

The foregoing example indicates that there is 90% chance given the simulations run for the power system component values that the balloon for which the simulation was run will be at the first position in the table. If that position is over a densely populated area and that is an undesirable outcome, the operator, post-processing system, or other automation consuming the results of this analysis may then modify the flight plan for the simulated balloon so that it steered away from that location. Alternatively, if the most likely position of the balloon is over an area considered to be safe for operation, attention may then be directed to other balloons in the system that may require more immediate attention.

Such a simulation may be carried out by running multiple simulations with another system parameter being modified within a range of values, with the outcome of the simulations providing a battery level. For example, a request for the Monte Carlo service may comprise simulating the solar charge of the battery will receive for a range of possible values given a planned flight path of the balloon. The output of the simulations may be values of power level when the balloon reaches the desired final destination. Once a satisfactory number of simulations have been run, the outcomes provide a prediction or risk assessment of the probability of the battery level being at, above or below different power levels. Examples of possible outcomes may comprise for example:

| | % Result of the Simulation |
|---|---|
| Battery Level | (e.g., out of a 1,000 simulations) |
| 70% | 95% |
| 60% | 84% |
| 50% | 72% |
| 10% | 8% |
| 5% | 4% |

As indicated by the above example, assuming the critical battery level to be 10%, the results indicate that for simulation conditions that particular outcome occurred only 8% of time. Therefore, that may be considered a low risk event and may be treated as such.

Although there may be many parameters that may need to be simulated and the balloon network may comprise hundreds or even thousands of balloons, the Monte Carlo service is provided in a manner that allows for timely management of the network, e.g., flight path adjustment, risk mitigation such as landing a balloon over a desolate area, etc. In addition, demand for the Monte Carlo service may be relatively high given the scale of the system that is being simulated, e.g., the size of the network and number of parameters for which simulations may be run. To meet the demand and provide results in a timely fashion, the service may be implemented so that block 514 generates simulation requests periodically for all the balloons or other platforms in a system. For example, simulation requests may be generated every 1 to 10 seconds, or more or less. Typically the service runs periodically and autonomously for all the balloons or flight systems in the network. In such an implementation, each simulation engine in the simulation environment 540 may then run a simulation for a particular scenario.

In order to manage potential demands for the service, e.g., to reject potential demands for service to ensure demand spikes can be discarded and the service can return to operation rather than have an indefinite backlog, the service may be run with a timeout threshold as indicated at block 518. In addition, or alternatively, simulations may also be run in the simulation environment 540 using multiple simulation engines 540₁, 540₂ . . . 540_{N}, which are illustratively depicted as forming a simulator 540 in FIG. 5. Although each engine is shown within a simulator block, in practice each engine may be distributed across different actual computing resources, systems or servers, e.g., different computing systems 400 of FIG. 4. As such, in a distributed architecture, each engine may run on a different computing device and use instructions distributed in a cloud computing environment. Each computing device may take the form of computing device 410 shown in FIG. 4. Alternatively, a computing device may comprise a virtual machine running on a host system. The use of a timeout threshold and/or multiple simulation engines running in parallel allow for timely simulation of a large scale multi-parameterized system such as the balloon network example discussed above.

The timeout threshold at block 518 for an individual request may be set, for instance, on order of seconds, for example 1-10 seconds or more or less. Thus, in one example, every 10 seconds one or more of the simulation engines 540₁ . . . 540_{N} is made available for a new simulation. The timeout threshold may be customizable and set based on the scale of the system, the number of simulation engines available, and/or features associated with the components being evaluated. If the number of balloons, or more generally objects or systems or nodes, within a network are less than the number of simulation engines, the timeout threshold may be lengthened as each balloon for which simulation is being run may have one or more engines available. On the other hand, where the number of nodes within the system for which simulated is requested outnumber the number of engines, the timeout threshold may be lowered in order to meet the demand for timely results.

The engines 540₁ . . . 540_{N} may be used in parallel to run simulations for a given balloon for a given parameter. For instance, in keeping with the battery level example, one engine may be run with a first system parameter being varied, while a second engine may be run with a second system parameter being varied, a third with a third and so on. The simulations that are run on the different engines may be run independent of each other. Therefore, at the end of 10 seconds, multiple outcomes may be provided for battery levels based on simulations associated with different parameters independently run on the different engines.

As shown at diamond 522, a determination is made of the success of a given simulation run within the time threshold. For example, if the simulation is set to run a number (N) of times, success may be determined by requiring that some predetermined number of simulations run in order for the simulation to be deemed useful. If N was equal to 1,000, it may be required that 70% of the simulations, or 700, simulations be run for the results to be used. The criteria used to determine whether to use a given simulation is customizable and may be dependent on how critical a given parameter is to continued delivery of service or whether the balloons are operating over a populated area. A balance may be struck with regard to confidence level required of results and the need to provide feedback as part of the service. For example, if all 100% of the simulations need to be run for a large scale system, results that may be used may not be generated frequently enough. Conversely, if too few simulations are employed, the results relied upon may be untrustworthy. The number of runs N may also be customizable, for instance depending on the rarity of the event being predicted or evaluated. By way of example, if the event is expected to happen somewhat often, then N=1,000 simulations may be sufficient. However, if it is important to gain insight about something that may only happen very infrequently (e.g., 1% of the time), then N may be set to upwards of 10,000 to 100,000 simulations.

If at block 522 it is determined that the required percentage of simulations did not run, the simulation is stopped and the results discarded at block 526. Simulations may be stopped for different reasons. For example, if the simulation outputs are too large, the time threshold is exceeded, the data outputted is unreliable or no initial state is available the simulation is stopped or terminated. On the other hand, if it is determined that the required percentage of simulations did run, the simulations results undergo post processing at block 530. Post processing may comprise merging the simulation results to form a composite risk factor. For example, different simulations may indicate risk factors relating to a critical battery level for different simulations. Post processing may also comprise making recommendations regarding the operation of the objects that make up the system. In the case of the balloon network, post processing may comprise making recommendations regarding the flight plan, power system management of a given balloon. Post processing may also include time stamping the simulation results.

After post-processing the output of service block 510 is provided to storage 560 as indicated by the dash-dot line 550. The output may comprise the simulation results 564 and recommendations 566. Storage 560 has update timer 568 to avoid data or result staleness. The update timer may be set to, e.g., 10 to 30 minutes or more or less, and is customizable. As an example, once the update timer reaches its time limit, the simulation results 564 and recommendations 566 that are considered stale are discarded. In another example, staleness can cause an alert to be sent to an operator (e.g., flight or system engineer). In dynamic systems such as a balloon system, stale simulation results may not reflect the current state of the system and reliance on such data may not be effective in managing the system.

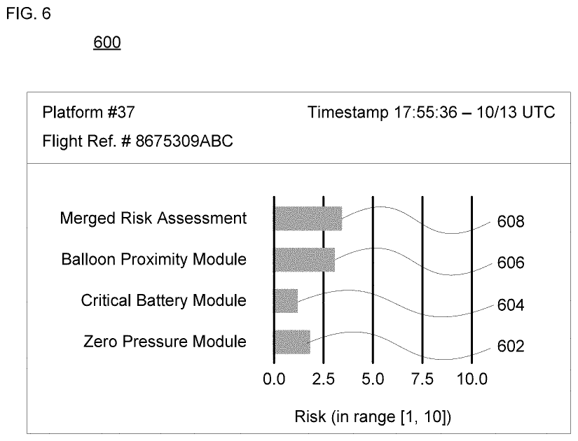

FIG. 6 shows an example of output 600 for a particular platform (e.g., balloon) that may be provided as a result of running the service 510. As shown, the output includes risk assessments for various simulation modules associated with the platform, including zero pressure 602, critical battery 604, and balloon proximity 606. A merged risk assessment 608 is also provided. The merged risk assessment 608 combines the risk assessment for each of zero pressure 602, critical battery 604 and balloon proximity 604. The risk is on a scale of 1 to 10, although it could also be a different scale or percentage. As shown, risk values for zero pressure 602 and critical battery 604 are below 2.5, while balloon proximity 606 is slightly above 2.5. The merged risk assessment 608 is on the order of 3.0 for this balloon simulation. The merged risk assessment 608 may be a weighted combination of the other results. Given this, the balloon associated with these simulation results may be determined to have a low risk for balloon termination. Therefore, it may be decided that no changes need to be made to the balloon's operation during the current phase of operation.

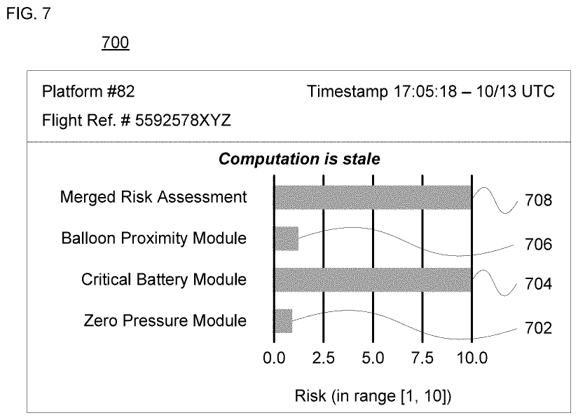

FIG. 7 shows an example of output 700 that may be provided as a result of running the service 510. In this example, the simulation results regarding zero pressure 702 and balloon proximity 706 are relatively low, while the result for critical battery 704 is extremely high. As with FIG. 6, the risk is on a scale of 1 to 10, although it could also be a different scale or percentage. As shown, the merged risk assessment 708 for this simulation is dominated by the risk assessment for the critical battery 704 module. The result of this simulation indicates this particular balloon is at risk, (approximately a 100% risk) for flight termination. In this case, it may be determined that corrective action will need to be taken. Such corrective action may generated automatically by other systems to which the simulation results may be fed. Such systems may include alerts system to message a operator or fleet parameter storage to change a parameter. In effect, such receiving systems may evaluate the risk factor results and may then alter the flight path, terminate flight at a desired time and place, etc. As can be also seen from FIG. 7, the results shown are denoted as stale. As discussed above, outputs from the system may be denoted as stale so that downstream systems that receive the outputs may know to discard them after a given time period. Staleness may be made possible by publishing the outputs with an expiration time. As the balloon network must be managed dynamically, expiration times will typically be on the order of minutes, e.g., 5 to 50 minutes, depending on the number of balloons in the system and other factors.

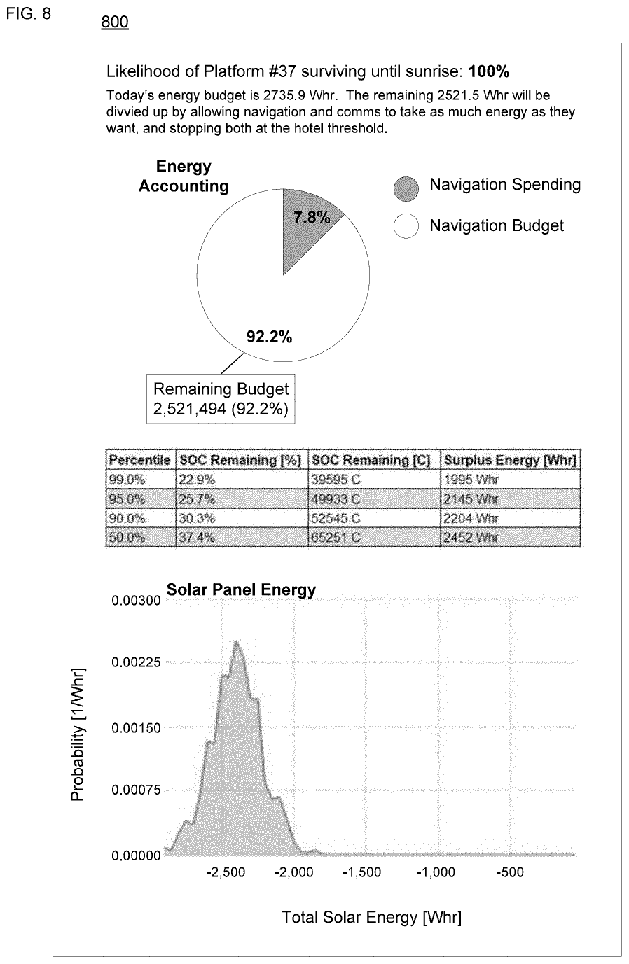

FIG. 8 shows an example of output 800 that may be provided as a result of running the service 510. In this example, a debug page for a critical battery module is shown. The information may provide an energy accounting for a given period of time, e.g., until sunrise, and may indicate how much energy has been spent and how much remains available for the time period. Debug pages allow engineers developing the system to assess what is happening with the state of particular systems and what tasks are being carried out by the code. This example shows how energy is divided among subsystems, the distribution over power level at sunrise (which is a criteria for assessing whether power will run out), and how much power is expected to be generated by the system's solar panels.

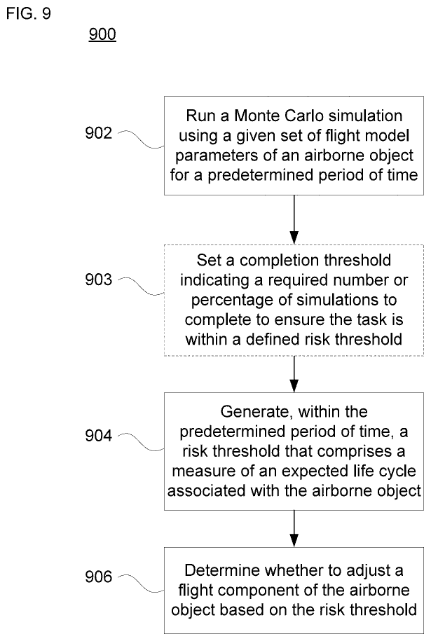

FIG. 9 illustrates one example 900 of a method for forecasting risk factors for an airborne platform controlled based on flight model parameters. As shown in block 902, the process includes running a Monte Carlo simulation using a given set of flight model parameters of the airborne object for a predetermined time period. The Monte Carlo simulation is distributed across a plurality of processing devices and run over ranges of values for the given set of flight model parameters, for instance as described above with regard to FIG. 5.

At block 904, the process also includes generating by one or more processors, within the predetermined time period, a risk threshold as a result of the Monte Carlo simulation. The risk threshold comprises a measure of an expected life cycle associated with the airborne object. And at block 906, the process includes determining whether to adjust a flight component of the airborne object based on the risk threshold.

The simulation distribution may include allocating evaluation of certain parameters on different devices or virtual machines. However, due to the complexity of distributed computation, the system may not rely on every shard or parcel of work to finish in a short threshold of time. Thus, in one aspect the system may require only x % (and/or an absolute number) of simulations to succeed (complete), for instance by setting a completion threshold as shown in block 903.

In order to determine an acceptable percentage or absolute number for completion, one may assume that each simulation is independent, identically distributed (iid), then that means that any number of simulations is not more biased than the larger set. The variance on the estimate of some parameter decreases with the number of simulations completed. One way to address this is to do a hypothesis test to say the system is below a selected risk parameter threshold with some confidence level a.

However, according to one aspect of the technology, the system does not presume each simulation's likelihood of failure is independent and uncorrelated with the set of parameters. Consider, for example, a simulation of how long a balloon is supposed to remain airborne, e.g., in the stratosphere. Here, the system simulates a balloon flying in the stratosphere forward in time until the simulation indicates the balloon would fall out of the sky. The time until falling out of the sky is returned as a result, and an average is computed across all simulations being run with the same or similar sets of parameters. Each simulation will have a timeout, e.g., between 10-60 seconds, 2-5 minutes, or more or less, to prevent the system from waiting forever on a, for example, datacenter machine that is in a stuck state. Because longer living balloons take longer to simulate and longer simulations are more likely to time out, there is a systematic underestimation of the mean. Thus, if one is looking for the mean to be less than a threshold as the criterion to watch out for, even a standard hypothesis test is not sufficient to determine how many simulations can be dropped to have an a confidence level that the mean is less than the threshold.

Instead, here the approach may be conservative, e.g., by assuming the type of correlation given in the example above does exist. Using a Boolean example for simplicity, suppose the system is evaluating a risk of experiencing a zero pressure (ZP) condition (or running out of battery power, etc.) at a future point in time (e.g., by midnight tonight) and the threshold is to assume with at least 90% certainty that this condition is not going to happen. The Boolean expression indicates that the likelihood of zero pressure is the number of zero pressures that are returned in individual simulations divided by the total number of simulations. Here, to satisfy the threshold, the zero pressure result needs to be less than 0.1. Thus, an equation (E) for zero pressure may be expressed as:

E[zp]=1/N\sum_{i=0}\hat{ }N 1(sim_i=ZP)<0.1

Where sim_i is the simulation number. The result of E[zp] can be divided into the simulations that have finished and those that have not finished. Thus:

E[zp]=1/N[\sum_{i=0}\hat{ }j1(sim_i=ZP)+\sum_{i=j}\hat{ }N1(sim_i=ZP)]

Assume that simulations j to N fail:

1/N[\sum_{i=0}\hat{ }j1(sim_i−ZP)+(N−j)]<0.1

Here, then the simulation process is in good shape because this is the worst case result if the system waited for all simulations to finish. Rearranging and making 0.1 be T to indicate any general threshold needed results in:

\sum_{i=0}\hat{ }j1(sim_i=ZP)<T*N−(N−j)

Thus, if all simulations complete, the result is back to the original as N−j=0 and thus both sides of the equation can be divided by N. This means that the system has a stopping criteria that can be checked after some of the simulations are completed to see if it is useful to wait for the rest or cancel them. Or the system can use this as the time limit for the overall estimation to occur to say whether it is able to make a valid estimation or not. In one example, some additional buffer could be added (e.g., via a standard statistical method) to account for the underlying variance of the quantity under evaluation.

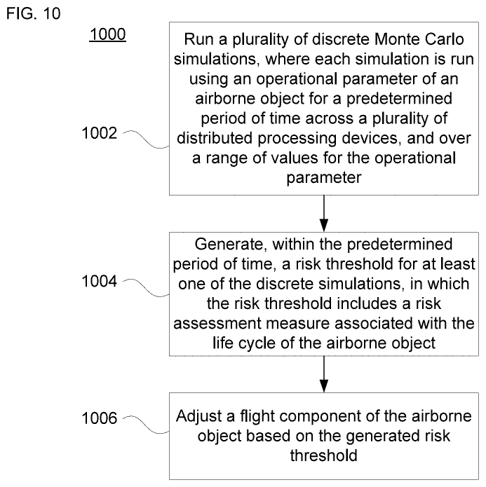

FIG. 10 illustrates one example 1000 of a method for managing risk assessment for a life cycle of an airborne object while the airborne object is in flight. As shown in block 1002, this includes running a plurality of discrete Monte Carlo simulations. Here, each discrete Monte Carlo simulation is run using an operational parameter of the airborne object for a predetermined time period and on a plurality of processing devices distributed on a network, as well as over a range of values for the operational parameter. At block 1004, the process includes generating, within the predetermined time period, a risk threshold for at least one of the plurality of discrete Monte Carlo simulations. The generated risk threshold comprises a risk assessment measure associated with the life cycle of the object. And then at block 1006 the process includes adjusting a flight component of the object based on the generated risk threshold.

The following described exemplary aspects of the technology:

1. A method for forecasting risk factors for an airborne object controlled based on flight model parameters, comprising:

running a Monte Carlo simulation using a given set of the flight model parameters of the airborne object for a predetermined time period, wherein the Monte Carlo simulation is distributed across a plurality of processing devices and run over a ranges of values for the given set of flight model parameters;

generating by one or more processors, within the predetermined time period, a risk threshold as a result of the Monte Carlo simulation, the risk threshold comprising a measure of an expected life cycle associated with the airborne object; and

determining whether to adjust a flight component of the airborne object based on the risk threshold.

2. The method of 1, wherein the given set of flight model parameters comprises one or more of a power level of a battery of the airborne object, a zero pressure condition of the airborne object, a location of the airborne object, or a weather parameter associated with a flight path of the airborne object.

3. The method of 1 or 2, further comprising terminating the Monte Carlo simulation if the risk threshold is not generated within the predetermined time period.

4. The method of any one of 1-3, further comprising repeatedly running the Monte Carlo simulation and generating a respective risk threshold for each repeated run.

5. The method of any one of the preceding 1-4, wherein the plurality of processing devices comprises a plurality of virtual machines.

6. The method of 5, wherein the plurality of virtual machines is distributed over a computer network.

7. The method of 5 or 6, wherein one or more of the given set of flight model parameters are allocated to different ones of the plurality of virtual machines during running of the Monte Carlo simulation.

8. The method of any one of the preceding 1-7, wherein the predetermined time period is on a time scale of seconds, minutes or hours.

9. The method of any one of the preceding 1-8, further comprising adjusting the flight component of the airborne object while the airborne object is in flight.

10. The method of any one of the preceding 1-9, wherein the Monte Carlo simulation is run while the airborne object is in flight.

11. A simulator system, comprising:

a plurality of computing devices distributed on a network,

one or more computer readable storage media; and

program instructions, stored on the one or more computer readable storage media, for execution by the plurality of computing devices, the program instructions comprising:

running a plurality of discrete Monte Carlo simulations, each discrete Monte Carlo simulation being run for an operational parameter of an airborne object for a predetermined time period and on the plurality of computing devices distributed on the network and over a range of values for the operational parameters;

generating, within the predetermined time period, a risk threshold for at least one of the plurality of discrete Monte Carlo simulations, the generated risk threshold comprising a risk assessment measure associated with a life cycle of the airborne object; and

outputting the risk threshold to a control system associated with the airborne object.

12. The simulator system of 11, further comprising the control system, wherein the control system is configured to adjust a flight path of the airborne object according to the risk threshold while the airborne object is in flight.

13. The simulator system of 11 or 12, wherein the program instructions are further configured to cause the plurality of computing devices to terminate a given one of the discrete Monte Carlo simulations when the risk threshold is not generated within the predetermined time period.

14. The simulator system of any one of 11 to 13, wherein the plurality of discrete Monte Carlo simulation is run while the airborne object is in flight.

15. The simulator system of any one of 11 to 14, wherein the plurality of computing devices comprises a plurality of virtual machines, and the plurality of discrete Monte Carlo simulations is distributed across the plurality of virtual machines.

16. The simulator system of 15, wherein the plurality of virtual machines is distributed over a computer network.

17. A method for managing risk assessment for a life cycle of an airborne object while the airborne object is in flight, comprising:

running a plurality of discrete Monte Carlo simulations, each discrete Monte Carlo simulation being run using an operational parameter of the airborne object for a predetermined time period and on a plurality of processing devices distributed on a network and over a range of values for the operational parameter;

generating, within the predetermined time period, a risk threshold for at least one of the plurality of discrete Monte Carlo simulations, the generated risk threshold comprising a risk assessment measure associated with the life cycle of the object; and

adjusting a flight component of the object based on the generated risk threshold.

18. The method of 17, wherein the plurality of discrete Monte Carlo simulations is run in parallel.

19. The method of 18, wherein at least some of the plurality of discrete Monte Carlo simulations are run using a same operational parameter.

20. The method of 18 or 19, wherein at least some of the plurality of discrete Monte Carlo simulations are run using different operational parameters of the airborne object.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for forecasting risk factors for an airborne object controlled based on flight model parameters, comprising:
running a Monte Carlo simulation using a given set of the flight model parameters of the airborne object for a predetermined time period, wherein the Monte Carlo simulation is distributed across a plurality of processing devices and run over ranges of values for the given set of flight model parameters;
generating by one or more processors, within the predetermined time period, a risk threshold as a result of the Monte Carlo simulation, the risk threshold comprising a measure of an expected life cycle associated with the airborne object; and
determining whether to adjust a flight component of the airborne object based on the risk threshold.

2. The method of claim 1, wherein the given set of flight model parameters comprises one or more of a power level of a battery of the airborne object, a zero pressure condition of the airborne object, a location of the airborne object, or a weather parameter associated with a flight path of the airborne object.

3. The method of claim 1, further comprising terminating the Monte Carlo simulation if the risk threshold is not generated within the predetermined time period.

4. The method of claim 1, further comprising repeatedly running the Monte Carlo simulation and generating a respective risk threshold for each repeated run.

5. The method of claim 1, wherein the plurality of processing devices comprises a plurality of virtual machines.

6. The method of claim 5, wherein the plurality of virtual machines is distributed over a computer network.

7. The method of claim 5, wherein one or more of the given set of flight model parameters are allocated to different ones of the plurality of virtual machines during running of the Monte Carlo simulation.

8. The method of claim 1, wherein the predetermined time period is on a time scale of seconds, minutes or hours.

9. The method of claim 1, further comprising adjusting the flight component of the airborne object while the airborne object is in flight.

10. The method of claim 1, wherein the Monte Carlo simulation is run while the airborne object is in flight.

11. A simulator system, comprising:
a plurality of computing devices distributed on a network;
one or more computer readable storage media; and
program instructions, stored on the one or more computer readable storage media, for execution by the plurality of computing devices, the program instructions comprising:
running a plurality of discrete Monte Carlo simulations, each discrete Monte Carlo simulation being run for an operational parameter of an airborne object for a predetermined time period and on the plurality of computing devices distributed on the network and over a range of values for the operational parameter;
generating, within the predetermined time period, a risk threshold for at least one of the plurality of discrete Monte Carlo simulations, the generated risk threshold comprising a risk assessment measure associated with a life cycle of the airborne object; and
outputting the risk threshold to a control system associated with the airborne object.

12. The simulator system of claim 11, further comprising the control system, wherein the control system is configured to adjust a flight path of the airborne object according to the risk threshold while the airborne object is in flight.

13. The simulator system of claim 11, wherein the program instructions are further configured to cause the plurality of computing devices to terminate a given one of the discrete Monte Carlo simulations when the risk threshold is not generated within the predetermined time period.

14. The simulator system of claim 11, wherein the plurality of discrete Monte Carlo simulation is run while the airborne object is in flight.

15. The simulator system of claim 11, wherein the plurality of computing devices comprises a plurality of virtual machines, and the plurality of discrete Monte Carlo simulations is distributed across the plurality of virtual machines.

16. The simulator system of claim 15, wherein the plurality of virtual machines is distributed over a computer network.

17. A method for managing risk assessment for a life cycle of an airborne object while the airborne object is in flight, comprising:
running a plurality of discrete Monte Carlo simulations, each discrete Monte Carlo simulation being run using an operational parameter of the airborne object for a predetermined time period and on a plurality of processing devices distributed on a network and over a range of values for the operational parameter,
generating, within the predetermined time period, a risk threshold for at least one of the plurality of discrete Monte Carlo simulations, the generated risk threshold comprising a risk assessment measure associated with the life cycle of the object; and
adjusting a flight component of the object based on the generated risk threshold.

18. The method of claim 17, wherein the plurality of discrete Monte Carlo simulations is run in parallel.

19. The method of claim 18, wherein at least some of the plurality of discrete Monte Carlo simulations are run using a same operational parameter.

20. The method of claim 18, wherein at least some of the plurality of discrete Monte Carlo simulations are run using different operational parameters of the airborne object.
